(19) United States
(12) Patent Application Publication
(10) Pub. No.: US 2009/0082453 A1
(43) Pub. Date: Mar. 26, 2009

(54) Exogenous Methyl Dihydrojasmonate for Prevention and Control of Biotic Attack in Plants

(75) Inventors: Barbara Scheer, San Francisco, CA (US); Justin Scheer, San Francisco, CA (US)

Correspondence Address: PATENTBEST, 4600 ADELINE ST., #101, EMERYVILLE, CA, 94608, US

(73) Assignee: NEW BIOLOGY, INC., Burlingame, CA (US)

(21) Appl. No.: 12/235,654

(22) Filed: Sep. 23, 2008

Related U.S. Application Data
(60) Provisional application No. 60/974,989, filed on Sep. 25, 2007.

(51) Int. Cl. A01N 37/08; A01G 9/00

(52) U.S. Cl. 514/572; 47/1.1 R

(57) ABSTRACT

Formulations and methods for treating and preventing biotic attack, including disease and insect infestation, in plants are disclosed. The formulations include methyl dihydrojasmonate:

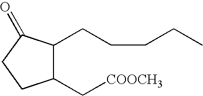

Formulations according to embodiments of the invention are particularly suitable for controlling insect infestation and disease in roses.

### CROSS-REFERENCE TO RELATED APPLICATIONS

This application claims priority to, and the benefit of, U.S. Provisional Patent Application No. 60/974,989, filed on Sep. 25, 2007. The contents of that application are incorporated by reference herein in their entirety.

### BACKGROUND OF THE INVENTION

1. Field of the Invention

Generally speaking, the invention relates to the field of plant biology, and more particularly, to methods for controlling biotic attack, including insect infestation and disease, in plants.

2. Description of Related Art

The jasmonates are a family of compounds related to jasmonic acid, 2-(3-oxo-2-(pent-2-enyl)cyclopentyl)acetic acid, the structure of which is shown below in Formula (I):

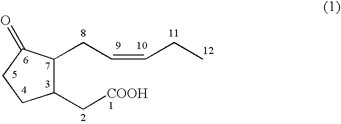

Jasmonates have been implicated in regulating a number of events in plant growth and development, as well as numerous types of plant responses to stressors. Osmotic stress or desiccation, touch, elicitation, wounding and pathogen and insect attack are all generally accompanied by increases in endogenous levels of jasmonates. Jasmonates are also widely used as flavoring and fragrance compounds because of their strong odor and taste characteristics.

Because of their apparent importance in plant life cycle events and stress responses, there have been studies of the relative bioactivity of various jasmonate compounds in single plant species (e.g., Miersch et al., Phytochemistry 50 (1999), pp. 353-361). There have also been studies of selected jasmonate compounds across multiple species (e.g., Gundlach and Zenk, Phytochemistry 47 (1998), pp. 527-537).

To date, the literature has shown that the bioactivity of different jasmonate compounds is different in each species, and that the bioactivity of the same jasmonate compound may vary greatly from one species to another. Simply put, the various members of the jasmonate family are not equally bioactive or equally efficacious for any particular purpose, and the extent of their effects is difficult to predict from one species to another.

Among the most commonly studied jasmonates is methyl jasmonate (MJ), the methyl ester of jasmonic acid, the general structure of which is given below in Formula (2):

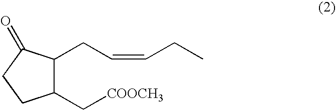

For example, MJ has been studied for the purpose of controlling Botrytis rot in roses (Mier et al., Postharvest Biology and Technology 13 (1998), pp. 235-243); and as an adjunct to be used in combination with other conventional chemicals to increase their effectiveness (e.g., U.S. Pat. No. 7,176,163 to Takahashi). Those studies have shown some positive results.

However, MJ is only one of a large family of jasmonates, many of which have not been studied extensively or at all. One jasmonate that has not been widely studied is the 9,10-dihydro form of methyl jasmonate, commonly referred to as methyl dihydrojasmonate (MDHJ), the general structure of which is given below in Formula (3):

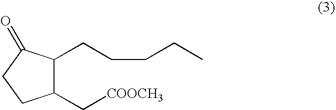

When it has been studied, MDHJ has been found to be less bioactive than either MJ or jasmonic acid (e.g., Miersch et al., 1998). In cell suspension cultures of E. californica, MDHJ induced benzo[c]phenanthridine alkaloid synthesis at a concentration, 10 μM, that was five times the concentration of MJ required to produce the same effect (Blechert et al., Proc. Natl. Acad. Sci. USA 92 (1995), pp. 4099-4105). Other studies on gene expression with tobacco plants have also shown that MDHJ typically has only a small fraction of the bioactivity of MJ (Ishikawa et al., Plant Molecular Biology 26 (1994), pp. 403-414).

However, although particular studies have established that one jasmonate compound may be quantifiably more active and/or efficacious than another in a particular species of plant under particular conditions, the literature as a whole demonstrates that the activity and/or effectiveness of any particular jasmonate in any particular species of plant cannot necessarily be predicted by or correlated to the activity and/or effectiveness of any other jasmonate.

### SUMMARY OF THE INVENTION

One aspect of the invention relates to a formulation for preventing or controlling biotic attack in a plant. The formulation comprises a solution of methyl dihydrojasmonate in a concentration ranging from about 0.15 mM to about 5 mM, and an exposure-increasing ingredient.

Another aspect of the invention relates to another formulation for preventing or controlling biotic attack in a plant. The formulation comprises methyl dihydrojasmonate in solid form in an amount ranging from about 0.008% to about 0.8% by weight, and a binder.

Yet another aspect of the invention relates to a method of preventing and treating biotic attack in a plant. The method comprises administering an effective amount of exogenous methyl dihydrojasmonate to the plant or to a growth medium in which the plant is being grown.

A further aspect of the invention relates to a cut rose produced by a process comprising applying exogenous methyl dihydrojasmonate to a rose plant or to a growth medium in which the rose plant is being grown in an amount effective to prevent or control biotic attack at least once, and, at a defined time after applying the exogenous methyl dihydrojasmonate, cutting the rose.

Other aspects, features, and advantages of the invention will be set forth in the description that follows.

### BRIEF DESCRIPTION OF THE DRAWINGS

The invention will be described with respect to certain drawing figures, in which:

FIG. 1 is a graph illustrating the results of a comparison of the effects of four elicitors of plant defense, including MDHJ, on proteinase inhibitor levels in tomato seedlings;

FIG. 2 is a graph illustrating the results of a comparison of the effects of MJ, MDHJ, and an untreated control on polyphenol oxidase induction in tomato seedlings;

FIG. 3 is a graph illustrating the effects of oil and surfactant inert ingredients, when combined with a known elicitor, on the level of proteinase inhibitors in lower tomato leaves;

FIG. 4 is a graph illustrating the effects of oil and surfactant inert ingredients, when combined with a known elicitor, on the level of proteinase inhibitors in upper tomato leaves;

FIG. 5 is a graph illustrating polyphenol oxidase activity in field-grown roses treated with MJ and MDHJ;

FIG. 6 is a graph illustrating trypsin inhibitor activity in roses;

FIG. 7 is a graph illustrating mean numbers of aphids on plants treated with a number of formulations;

FIG. 8 is a graph illustrating the aphid counts on each plant in the data of FIG. 7;

FIG. 9 is a photograph of an untreated tomato seedling, illustrating the damping off disease on the leaves;

FIG. 10 is a photograph of a tomato seedling treated with MDHJ, taken 17 days after treatment, showing healthy leaves, as compared with the tomato seedling of FIG. 9;

FIG. 11 is a photograph of an untreated tomato seedling taken from the side, illustrating the damping off disease on the leaves;

FIG. 12 is a photograph of a tomato seedling treated with MDHJ, taken 17 days after treatment, showing healthy leaves, as compared with the tomato seedling of FIG. 11;

FIG. 13 is a graph illustrating roseslug incidence on MDHJ-treated and untreated potted rose;

FIG. 14 is a photograph illustrating roseslug damage in a number of leaves from untreated (top row) and MDHJ-treated potted rose (bottom row);

FIG. 15 is a graph illustrating the incidence of powdery mildew in plants treated with a number of formulations;

FIG. 16 is a graph illustrating rust severity in plants treated with a number of formulations; and

FIG. 17 is a graph illustrating the percent of flowers per plant with and without disease in two groups of plants, one of which was treated with MDHJ.

### DETAILED DESCRIPTION

The present inventors have found that exogenous 9,10-dihydromethyl jasmonate (MDHJ), administered in an effective amount, can treat and prevent biotic attack in a plant in need of such treatment. Moreover, the present inventors have found that MDHJ is surprisingly and unexpectedly at least as effective, and sometimes more effective, than methyl jasmonate (MJ) for that purpose.

Plants to which MDHJ may be applied include, but are not limited to, angiosperms, gymnosperms, monocots, dicots, roses, tomatoes, crop plants, ornamental plants, turf plants, shrubs, trees, exotic plants, house plants, and native plants in cultivated or natural environments. MDHJ has been found to be particularly efficacious in tomato plants and roses.

The term “biotic attack,” as used in this specification, refers to attack on a plant by a biological agent or organism including, but not limited to, microbial pathogens, insects, mites, and nematodes, that causes or would tend to cause a pathological condition in the plant. Particular microbes may include necrotrophic and biotrophic fungi; bacteria; oomycetes, such as powdery mildew; botrytis; black spot; viruses and pseudomonas, to name a few. Generally speaking, biotic attack, if unchecked, may result in infestation or disease in an affected plant.

The MDHJ may be applied alone or in a formulation comprising other elements, compounds, or substances. Some examples of other compounds that may be included in the formulation include wetting agents, adjuvants, emulsifiers, dispersants, spreaders, stickers, pastes, anchorage agents, fixatives, extenders, coating agents, buffering agents, plant nutrients, absorptive additives, and disintegrants. Those of skill in the art will recognize that a single ingredient may perform multiple functions, and may thus be classified or grouped in different ways. If the MDHJ is applied in the form of a foliar spray, it is generally desirable to include at least one exposure-increasing ingredient; i.e., at least one whose purpose is to increase the plant's exposure to the MDHJ or, more generally, to increase the influence of MDHJ on the plant. That exposure-increasing ingredient may be a wetting agent, a dispersant, a spreader, a sticker, an anchorage agent, a fixative, an extender, a coating agent, or an ingredient that acts by some other mechanism to increase plant exposure to MDHJ or to increase the influence of MDHJ on the plant. Exposure-increasing ingredients may or may not have discernible physiological effects on the plant when administered alone.

Particular examples of formulation ingredients include ionic, non-ionic, and zwitterionic surfactants, such as an octylphenoxypolyethoxyethanol-based surfactant like TRITON® X-100, TRITON® X-114, NP-40, SILWET, and sodium dodecyl sulfate; alcohols; organic solvents; synthetic or natural oils, such as castor oil, canola (rapeseed) oil, and soybean oil; soaps; and naturally derived adjuvants such as lecithin, saponin, and extracts from yucca, coconut, and pine. Each of these ingredients may be considered an exposure-increasing ingredient for purposes of this description.

In some embodiments, it may be beneficial to use ingredients that are high in compounds that play a role in the octadecanoic pathway. For example, canola oil is high in linoleic and linolenic acids, compounds that play a role in the octadecanoic pathway. Soaps of linoleic and linolenic acids may also be desirable formulation ingredients in some embodiments.

A formulation according to embodiments of the invention may also include fixative and extender compounds, in order to reduce volatility and evaporation of the active ingredient or ingredients, so as to increase exposure of the plant to the active ingredient. Exemplary fixatives include canola oil, castor oil, benzoyl benzoate, benzyl salicylate and synthetic musks, and sandalwood. Gums, waxes, and other carbohydrates, such as carnauba wax, carob gum, dextrins, dextrose, gellan gum, guar gum, paraffin wax, sorbitol, xanthan gum, polyvinylpyrrolidone, and glycerin, may also be used as fixatives.

Absorptive additives may also be included for extending the release and exposure time. Exemplary absorptive additives include, but are not limited to, silica gel; precipitated crystalline-free silica gel; amorphous, fumed, crystalline-free silica; amorphous, precipitated gel silica; silica hydrate; vitreous silica; silicic acid; and silicon dioxide.

Alone or in combination with other ingredients, the MDHJ may be delivered in the form of emulsions, suspensions, powders, hydrates, aqueous solutions, granules, pastes, aerosols, and volatile formulations. Any of these forms may be adapted for application to the plant's foliage, roots, stems, flowers, or any other portion of the plant that is capable of absorbing it. Particularly advantageous forms include foliar sprays, root solutions, and pellet-based root preparations. As a root solution or preparation, jasmonates such as MDHJ may be formulated and applied to plants grown in soil, non-soil, artificial growing media, and/or hydroponic systems. In some embodiments, the MDHJ formulations may be combined with other active compounds that can be administered in the same fashion as the MDHJ formulation. Examples include fertilizers, seaweed, kelp, humic acid, and microbes. An MDHJ foliar spray may be combined with a foliar fertilizer, and a root solution may be combined with a fertilizer that is applied to the roots. Specific fertilizer and plant nutrient elements include, but are not limited to, nitrogen, potassium, phosphorus, calcium, magnesium, which may be compounded in any known manner so as to be absorbable by the plant. For example, plant nutrients may include monobasic potassium phosphate (KHPO₄) and magnesium sulfate (MgSO₄).

As was described briefly above, the MDHJ would be applied in an “effective amount.” Generally speaking, an effective amount is any amount of MDHJ that produces an observable decrease in or absence of biotic attack in a plant. Alternatively, since MDHJ is an elicitor of natural plant defensive mechanisms and pathways, an effective amount of MDHJ may be defined as an amount of MDHJ sufficient to cause an observable increase in a known biochemical marker linked to plant defense to a level likely to correlate with an observable decrease in biotic attack in the plant.

Compounds involved in known jasmonate-induced biochemical responses that may be used as biochemical markers include the pathogenesis-related (PR) superfamily of genes (glucanases, chitinases, defensins (e.g., PDF1.2), thionins, cyclotides), phenolics, reactive oxygen species (e.g., hydrogen peroxide), signaling compounds such as MAP kinases, peptides upregulated by jasmonates (e.g., systemin, AtPep, LePep, etc.), proteinase inhibitors (e.g., PI-I, PI-II, cathepsin D inhibitor, elastase, carboxypeptidase, chymotrypsin, trypsin inhibitors, alpha-amylase inhibitors, aminopeptidases, etc.), polyphenol oxidase, anthocyanins, increased volatile emissions, phytoalexins, lipoxygenase, allene oxide synthase, allene oxide cyclase, peroxidase, alkaloids, stilbenes, beta-1-3 glucanases, polygalacturonase, terpenoids, flavenoids, alkaloids, anthraquinones, glucosinolates, and vegetative storage proteins.

Effective amounts of MDHJ will vary from species to species and cultivar to cultivar, and will depend on the manner of application, the environmental conditions around the plant or plants, the form in which the MDHJ is administered, and the nature and type of additive compounds, if any, present in the formulation with the MDHJ. For example, if an MDHJ formulation is applied over a substantial portion of a plant's foliage, or is applied using a formulation that includes wetting agents, fixatives, and/or other additives intended to increase the level of exposure of the plant to the MDHJ, the formulation itself may contain a smaller amount or lower concentration of MDHJ than if an MDHJ formulation is applied over only a small portion of a plant's foliage, or without additives intended to increase the plant's exposure to the MDHJ. Similarly, if the MDHJ is administered in a form that tends to dwell on the plant's foliage, or in proximity to another part of the plant, then it may be administered in a lower concentration or amount.

As one example, an effective amount of MDHJ may comprise an aqueous solution with an MDHJ concentration in the range from about 0.15 mM to about 5 mM, inclusive. However, for some purposes, and in some species, concentrations up to about 10 mM may be used. As those of skill in the art will realize, in general, MDHJ may be used in even higher concentrations for some applications, provided that the total dose of MDHJ that is absorbed by the plant is not phytotoxic. Similarly, lower concentrations may be adequate in some situations, for example, in an enclosed environment or greenhouse.

Regardless of the concentration or amount of MDHJ in preparations intended for use, MDHJ liquid formulations according to the present invention may be provided in the form of concentrates, so as to make shipping and distribution more efficient, and the task of preparing an appropriate suspension, solution, or other formulation for application may be left to the end user.

One example of an aqueous MDHJ foliar spray formulation suitable for direct application to plants is given below in Table 1.

TABLE 1
Exemplary Aqueous Foliar Spray Formulation

| | | | % by | % by |
|---|---|---|---|---|
| Ingredient | g/L | ml/L | weight | volume |
| Water | 993.411 | 993.411 | 99.2931% | 99.341% |
| Methyl | 0.339 | 0.339 | 0.0339% | 0.034% |
| Dihydrojasmonate | | | | |
| (1.5 mM) | | | | |
| Canola Oil | 4.600 | 5.000 | 0.4598% | 0.500% |
| Triton X-100 | 1.325 | 1.250 | 0.1324% | 0.125% |
| KHPO4 - 4 mM | 0.544 | | 0.0544% | |
| MgSO4 - 0.8 mM | 0.197 | | 0.0197% | |
| Citric Acid - 0.347 mM | 0.067 | | 0.0067% | |
| Total | 1000.483 | 1000.000 | 1.000 | 1.000 |

In addition to liquid and aqueous preparations, MDHJ or MJ may be formulated for use in a slow-release application and provided in a granular- or pellet-based form, including fertilizer and/or pesticide formulations. Concentrations of active ingredient, MJ or MDHJ, are effective in weight/weight ratios of MDHJ or MJ to other ingredients in the range of 0.008% to 0.8%, and in some cases an effective ratio could be greater than 1.0% or less than 0.008%. Other inert or nutritive ingredients included in the pellets or granules can include binding agents and polymers such as polysaccharides and polyvinylpyrrolidone at 5-95%, a surfactant at 0.001-10%, and other absorptive ingredients such as acrylamide and acrylamide polymers.

Formulations including MDHJ may be applied once or repeatedly, depending on the circumstances. For example, if intended as a preventative, MDHJ formulations according to embodiments of the invention may be applied to healthy plants, such as healthy roses, and may be reapplied, if desired, at regular intervals, such as every 10-14 days, every 30 days, or 1-2 times per month. As will be described below in the examples, the present inventors have found that once applied, MDHJ acts systemically, and can increase the levels of plant defensive compounds even in new growth that did not exist at the time of initial treatment. Therefore, depending on the growth cycle of the plant, in some circumstances, especially when the likelihood of biotic attack is low, it may not be necessary to reapply an MDHJ formulation.

Despite the ability of MDHJ to act systemically and produce prolonged effects in plants, one of the factors that may necessitate reapplication of an MDHJ formulation is the environmental conditions around the plant. For example, if the plants are field-grown or otherwise exposed to the elements, rain showers, excessive wind gusts, or other environmental factors shortly after an application may make a subsequent application desirable. Under some circumstances, a more dilute formulation or solution may be used if repeated applications are to be performed.

MDHJ formulations may be applied preemptively, for example, one week before an expected outbreak or biotic attack. They may also be applied to plants already suffering from insect infestation, disease, or other manifestations of biotic attack. Used in this manner as a treatment, the formulations may be applied a single time or repeatedly, depending on the totality of the circumstances and the severity of the biotic attack. During an acute biotic attack, an MDHJ formulation may be applied in conjunction with another compound, such as a pesticide or an antifungal compound.

### EXAMPLES

The following examples serve to illustrate the efficacy of MDHJ in various formulations, on various plants, and for different forms of biotic attack, as well as the efficacy of certain comparative formulations in the same circumstances.

Unless otherwise noted, in the following examples, the MDHJ was obtained from Bedoukian Research, Inc. (Danbury, Conn., United States; product no. 398E). As supplied, the MDHJ solution was specified as having a minimum purity of 92.5%, of which 25-40% was the “epi” or “cis” isomer of MDHJ, shown as Formula (4) below:

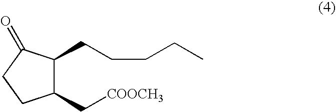

Unless otherwise noted, percentages, for example, percentages of additional or inert formulation ingredients, are given as percentages by volume. Additionally, in Examples 7-13, the insect and disease states of the plants were naturally occurring; the plants were not inoculated with an agent for the purpose of causing or facilitating biotic attack.

### Example 1

### Comparison of 4 Elicitors of Plant Defense on Proteinase Inhibitor Induction in Tomato

Seven test samples or groups were prepared using two week old tomato seedlings. The descriptions of the treatments given to each test sample can be found in Table 2 below.

Liquid formulations were applied by spraying three squirts to the foliage with a spray bottle. Eight plants per treatment (four pots per treatment, each pot containing two seedlings) were sprayed with each test formulation. Plants from each treatment were isolated in enclosed Plexiglas boxes and placed overnight in a light- and temperature-controlled growth chamber (i.e., plants given the same treatment were isolated together in a single Plexiglas box; plants given different treatments were in different boxes). Twenty-four hours after treatment, each plant was assayed for proteinase inhibitor I and II production by a radial immunodiffusion assay using anti-inhibitor antibodies (Ryan, C. A., Analytical Biochemistry 19 (1967), pp. 424-440, the contents of which are incorporated by reference in their entirety).

TABLE 2
Description of test samples for Example 1.

| Number | Description |
|---|---|
| 1 | Untreated control |
| 2 | Water |
| 3 | Inert Formulation (0.5% Canola Oil + 0.125% Triton ® X-100) |
| 4 | Wounded Plant (one lower leaf was wounded by crushing the |
| | midvein with forceps |
| 5 | Messenger ® (Eden Bioscience, Bothell, Washington, |
| | United States) harpin protein prepared according to label |
| | directions: 1 teaspoon of the product |
| | (containing 3% harpin protein) in 1 quart of water |
| 6 | 1.5 mM methyl dihydrojasmonate in water |
| 7 | 1.5 mM methyl jasmonate in water |

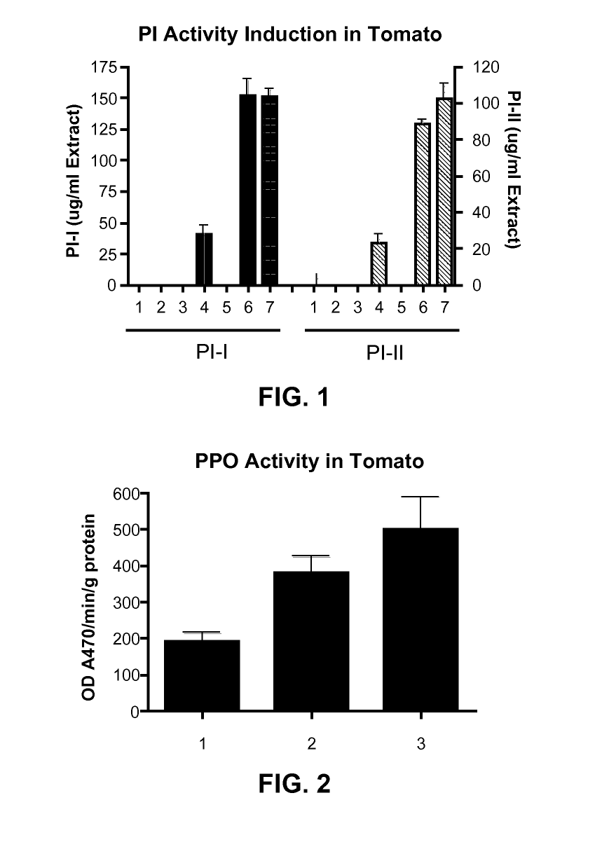

The results for each of the test samples are shown in FIG. 1, a graph in which proteinase inhibitor levels (PI-I and PI-II) are reported in micrograms of proteinase inhibitor per milliliter of leaf extract for each test sample. The two plants per pot were pooled to give one data point per pot (i.e., four data points total were collected per treatment).

In general, Example 1 illustrates that MDHJ can activate proteinase inhibitors in tomato, a well-known model plant for evaluating plant defense activation, to a similar level as methyl jasmonate, a known elicitor, and that both MJ and MDHJ can increase proteinase inhibitors to a much greater level than the plant's natural response to wounding. Additionally, Example 1 illustrates that MJ and MDHJ perform this effect without the need for other ingredients; alone, the inert ingredients of test sample #3 did not activate proteinase inhibitors.

Also of note is the fact that test sample #5, containing a commercial harpin protein preparation, which is considered a plant defense elicitor, did not activate proteinase inhibitors in tomato plants. This suggests that different or additional responses are activated by MJ and MDHJ as compared with other available plant defense elicitor products.

### Example 2

### Polyphenol Oxidase (PPO) Induction in Tomato Plants

Three test samples were prepared using tomato seedlings. The descriptions of the treatments given to each test sample can be found in Table 3 below.

Liquid formulations were applied by spraying three squirts to the foliage with a spray bottle. Seedlings from each treatment were isolated in plastic boxes (i.e., as in Example 1, plants given the same treatment were isolated together). Polyphenol oxidase assays were carried out on the entire foliage of each plant 24 hours after application (Stout, M. J., Brovont, R. A., and Duffey, S. S., J. Chemical Ecology 24:6, pp. 946-963, the contents of which are incorporated by reference in their entirety).

The assay procedure was as follows. Tomato leaflets were weighed and ground in 1 ml of ice-cold extraction buffer (0.1M sodium phosphate buffer, pH 7, containing 3.5% polyvinylpolypyrolidine). Following grinding, 0.4 ml of 10% Triton® X-100 was added to the leaf homogenate, mixed and centrifuged for 15 minutes at 2000×g at 4-degrees. Fifteen microliters of the resulting supernatant was added to 1 ml of PPO Assay Buffer (2.92 mM caffeic acid in pH 7 sodium phosphate buffer) and the change in absorbance at A470 was recorded every minute for 10 minutes. Change in absorbance rate (OD A470/min/g protein) reflects the rate of formation of a compound produced by the activity of PPO. The results of Example 2 are shown in FIG. 2, and reflect the mean and SEM for each treatment.

TABLE 3
Description of Test Samples for Example 2.

| Number | Description |
|---|---|
| 1 | Untreated control |
| 2 | 1.5 mM MDHJ + 0.5% canola oil + 0.125% Triton ® X-100 |
| 3 | 1.5 mM MJ + 0.5% canola oil + 0.125% Triton ® X-100 |

In general, the results of Example 2 establish the ability of MDHJ to activate PPO, a known biochemical marker linked to plant defense, in tomato plants.

### Example 3

### Effects of Formulation Inert Ingredients on Proteinase Inhibitors in Tomato After 7 Days

Four test samples were prepared using two week old tomato seedlings. The descriptions of the treatments given to each test sample can be found in Table 4 below.

Liquid formulations were applied by spraying three squirts to the foliage with a spray bottle. Each treatment was applied in a fume hood which drew air up and away from the plants. The seedlings from one treatment were allowed to dry for 30 minutes under the fume hood before being transferred to a bench in a separate room so that the next treatment could take place under the fume hood. Eight plants per treatment (four pots per treatment, each pot containing two seedlings) were sprayed with each test sample.

After drying, plants from each treatment were placed side-by-side and allowed to incubate for 7 days. Plants were then assayed for proteinase inhibitor I and II production by a radial immunodiffusion assay using anti-inhibitor antibodies, as in Example 1. The two plants per pot were pooled to give one data point per pot (4 data points total collected per treatment). Data were reported as mean and SEM of total micrograms of inhibitor per milliliter of leaf extract.

TABLE 4
Description of Test Samples for Example 3.

| Number | Description |
|---|---|
| 1 | Untreated control |
| 2 | 0.15 mM MJ in water |
| 3 | 0.15 mM MJ + 0.5% canola oil + 0.125% Triton ® X-100 |
| 4 | 0.15 mM MJ + 0.5% castor oil + 0.125% Triton ® X-100 + |
| | 0.1% xanthum |

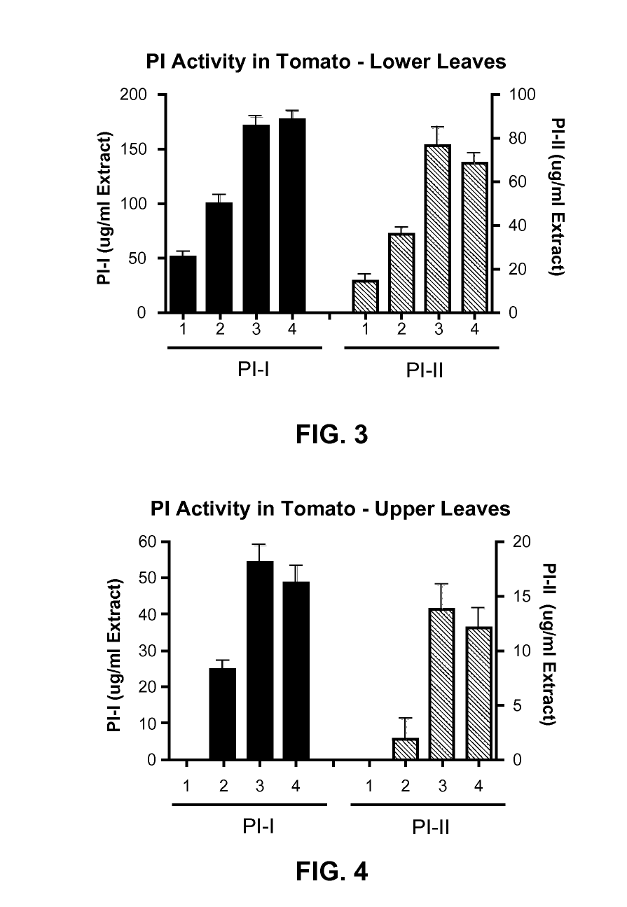

FIG. 3 is a graph of proteinase inhibitor I and II levels in the lower leaves of the tomato seedlings after seven days; FIG. 4 is a graph of proteinase inhibitor I and II levels in the upper leaves of the tomato seedlings after seven days.

Example 3 explores the effects of inert formulation ingredients on tomato seedlings using MJ, a known elicitor of plant defense mechanisms. Whereas exposing plants in isolated Plexiglas boxes tends to quickly produce a maximal response by prolonged exposure to the volatile jasmonates, by letting the plants dry and leaving them in the open air, one obtains data on the effects of the various formulations over time.

As can be seen in FIGS. 3 and 4, the addition of the inert ingredients increased proteinase inhibitor levels in the seedling leaves. Furthermore, FIG. 4 illustrates that in tomato seedling upper leaves—which formed after the treatment—the levels of PI-I and PI-II were more than double the levels measured in the control and wound treated samples, indicating that the active formulations increased proteinase inhibitor levels systemically over a sustained period in both old and new growth.

### Example 4

### Activation of Polyphenol Oxidase in Field-Grown Roses

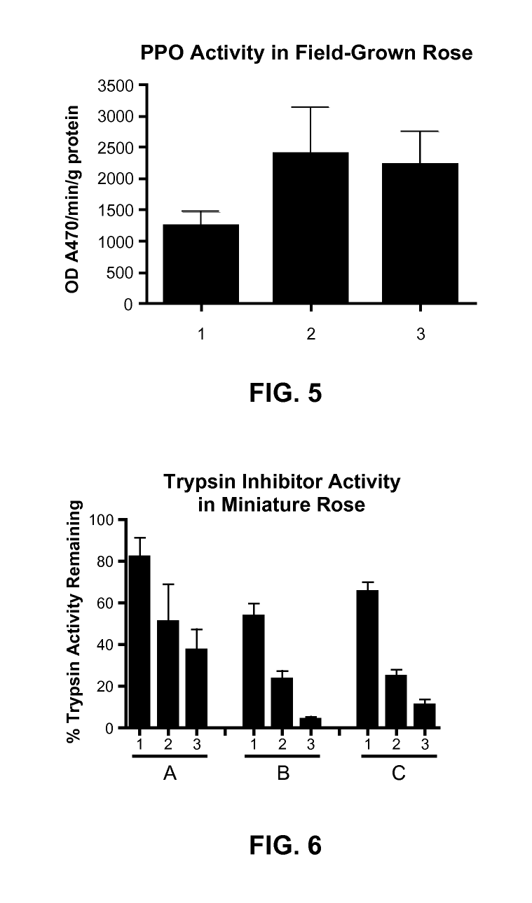

Field grown 1-year old ‘Julia Child’ roses were treated with foliar sprays of two different formulations. Roses were treated by spraying the foliage of each plant to the point of drip to ensure maximum coverage. There were three plants per treatment. 44 hours after application, 3 young leaves from each plant (each leaf from a different stem and all leaves at the same stage of development) were collected and pooled for analysis of PPO activity as in Example 2 above, except that 0.5 ml of ice cold extraction buffer were used, followed by addition of 160 μl 10% Triton® X-100. 50 μl of the supernatant was added to 1 ml of PPO assay buffer. The formulations are set forth in Table 5 below, and the data is shown FIG. 5, a graph of PPO activity for the two formulations and an untreated control. Data are reported as mean and SEM for each treatment.

TABLE 5
Test sample formulations for Example 4.

| Number | Description |
|---|---|
| 1 | Untreated control |
| 2 | 5 mM MDHJ + 0.5% canola oil + 0.125% + Triton ® X-100 |
| 3 | 5 mM MJ + 0.5% canola oil + 0.125% Triton ® X-100 |

The data, shown in FIG. 5, indicates increased PPO activity upon elicitation with MDHJ as well as MJ in the field-grown rose cultivar, “Julia Child.” The data also indicates that MDHJ can elicit plant defenses in field-grown roses to levels that are equal to or better than the levels seen after MJ application. Moreover, these effects can be seen in field-grown roses and other plants, which are subject to a full range of environmental conditions, including diseases and pests.

### Example 5

### Activation of PPO and Chymotrypsin Inhibitor in Outdoor-Potted Roses Treated with MJ and MDHJ

Potted plants of the polyantha rose cultivar ‘Little White Pet’ received one of four treatments. Roses were treated by spraying the foliage of each plant to the point of drip to ensure maximum coverage. Four plants were used for each treatment. 44 hours after treatment, all leaves from the entire plant were collected and pooled for analysis of PPO activity. Leaf extracts were prepared by adding 25 ml of 0.4 M sodium phosphate, pH 9, extraction buffer and 3 ml of 10% Triton® X-100 and grinding in a blender. The extract was then filtered through 4 layers of cheesecloth. One milliliter of extract was spun at 2000×g for 15 minutes and the resulting supernatant used in the PPO assay.

For the PPO assay, 30 μl of the above-prepared extract was added to 1 ml of PPO Assay Buffer (pH 9, 0.4 M sodium phosphate containing 10 mM L-DOPA (L-3-(3,4-Dihydroxyphenyl)alanine). The change in absorbance at A470 was recorded for all 16 samples every 10 minutes for 40 minutes.

For the chymotrypsin inhibitor assay, chymotrypsin inhibitor concentrations in leaf extracts previously prepared for the PPO assay were determined by titrating extracts into a chymotrypsin assay buffer containing 1.6 micrograms chymotrypsin and N Benzoyl L Tyrosine Ethyl Ester (BTEE) as a substrate.

Chymotrypsin inhibitor concentrations are reported in Table 7 as micrograms per milliliter of leaf extract.

The formulations are set forth in Table 6 below, and the data is shown in Table 7. PPO data are reported as mean and SEM of OD A470/min/g protein; chymotrypsin inhibitor results are reported as micrograms of inhibitor per milliliter of extract.

TABLE 6
Test sample formulations for Example 5.

| Number | Description |
|---|---|
| 1 | Untreated control |
| 2 | 1.5 mM MDHJ + water |
| 3 | 1.5 mM MDHJ + 0.5% canola oil + 0.125% Triton ® X-100 |
| 4 | 1.5 mM MJ + 0.5% canola oil + 0.125% Triton ® X-100 |

TABLE 7
Defense Biomarker Levels in Potted Rose

| | PPO | |
|---|---|---|
| | (A470/min/g fresh weight using L- | Chymotrypsin Inhibitor |
| Number | DOPA Substrate) | (μg inhibitor per ml extract) |
| 1 | 556 ± 20 | 89 ± 29 |
| 2 | 732 ± 70 | 114 ± 24 |
| 3 | 889 ± 153 | 175 ± 10 |
| 4 | 623 ± 96 | 87 ± 46 |

The results demonstrate that both PPO and chymotrypsin inhibitor activation by MDHJ are surprisingly greater than PPO and chymotrypsin inhibitor activation by MJ in the outdoor-grown, potted rose cultivar ‘Little White Pet.’ Additionally, the inert ingredients, canola oil and Triton® X-100 in this example, clearly enhance the efficacy of MDHJ. Moreover, the effects of MDHJ can be seen using two different PPO substrates, L-DOPA and caffeic acid, and at two different concentrations, 1.5 mM in this example and 5 mM in Example 4.

### Example 6

### Activation of Trypsin Inhibitor in Roses Treated with MJ and MDHJ

Potted plants of white miniature roses, marketed as Parade Rose® received one of three treatments. Roses were treated by (1) spraying the foliage of each plant to the point of drip to ensure maximum coverage; and (2) pouring 50 ml of the formulation into the soil within the root zone. There were three plants per treatment. 48 hours after treatment, all leaves from the entire plant were collected and pooled for analysis of trypsin inhibitor activity. Leaf extracts were prepared by adding 25 ml of 0.4 M sodium phosphate, pH 9, extraction buffer and 3 ml of 10% Triton® X-100 and grinding in a blender. The extract was filtered through four layers of cheesecloth. One milliliter of extract was spun at 2000×g for 15 minutes at 4-degrees and the resulting supernatant was frozen until the assay could be completed.

For the trypsin assay, rose extracts were thawed and replicates of 1, 2, and 3 μl for each extract were added to trypsin assay solution containing p-toluene-sulfonyl-L-arginine methyl ester (TAME) as the trypsin substrate. The level of trypsin activity was measured and reflects trypsin inhibition by trypsin inhibitor. The formulations are shown in Table 8 below. Data is shown in FIG. 6, a graph of the results, and is presented as the mean and SEM of % remaining trypsin activity per gram fresh weight for 1, 2, and 3 μl. In FIG. 6, lower values represent greater trypsin inhibitor activity.

TABLE 8
Test sample formulations for Example 6.

| Letter | Description |
|---|---|
| A | Untreated control |
| B | 5.0 mM MDHJ |
| | Foliage: 5.0 mM MDHJ + 0.5% canola |
| | oil + 0.125%Triton ® X-100 |
| | Roots: 5.0 mM MDHJ + 0.005% Triton ® X-100 |
| C | 5.0 mM MJ |
| | Foliage: 5.0 mM MJ + 0.5% canola oil + 0.125% Triton ® X-100 |
| | Roots: 5.0 mM MJ + 0.005% Triton ® X-100 |

The results of Example 6 demonstrate that roses also exhibit enhanced proteinase inhibitor activity when stimulated by MDHJ and MJ. As shown in FIG. 6, MDHJ surprisingly appears to enhance proteinase inhibitor activity to a greater degree than MJ.

### Example 7

### Field Studies Evaluating Efficacy in Controlling Aphid Infestations in Roses

Potted roses of the cultivar ‘Mr. Lincoln’ were treated with 9 treatment samples (8 formulations and one untreated control). For each treatment sample, three plots having three plants each were treated, for a total of 9 plants per treatment. Roses were treated every 10-13 days by spraying the foliage of each plant to the point of drip to ensure maximum coverage. The plants were evaluated at approximately 10-day intervals for the number of aphids on each plant. Table 8 below includes the descriptions of the test formulations.

TABLE 9
Test sample formulations for Example 7.

| Number | Description |
|---|---|
| 1 | Untreated control |
| 2 | 1.5 mM MJ + 0.5% canola oil + 0.125% Triton ® X-100 |
| 3 | 5.0 mM MJ + 0.5% canola oil + 0.125% Triton ® X-100 |
| 4 | 5.0 mM MJ + water |
| 5 | 1.5 mM MDHJ + 0.5% canola oil + 0.125% Triton ® X-100 |
| 6 | 5.0 mM MDHJ + 0.5% canola oil + 0.125% Triton ® X-100 |
| 7 | 5.0 mM MDHJ + water |
| 8 | 0.5% canola oil + 0.125% Triton ® X-100 |
| 9 | RUBIGAN (fenarimol: α-(2-chlorophenyl)-α-(4-chlorophenyl)- |
| | 5-pyrimidinemethanol) |

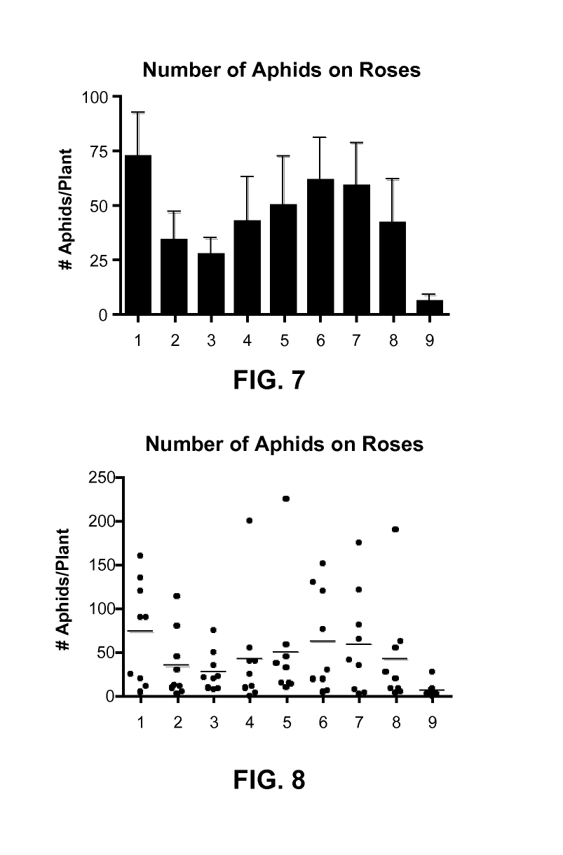

FIGS. 7 and 8 are two representations of the same data, taken at the height of aphid pressure. FIG. 7 is a histogram representing mean and SEM aphid counts on the roses with the various formulations. In FIG. 8, each data point represents the number of aphids on a single plant.

In general, the data do show the ability of MJ and MDHJ to reduce the incidence of aphids on roses, as demonstrated by the reduced aphid counts on plants treated with MJ and MDHJ. Test sample formulation no. 8, which contained canola oil and surfactant, also demonstrated an ability to reduce aphids on roses, and it is believed that the effects of those agents may be masking the effects of the MJ and the MDHJ.

Also noteworthy is the fact that in these results, MDHJ appears to be more efficacious at the lower concentration of 1.5 mM, whereas MJ appeared to be more efficacious at the higher concentration of 5 mM.

### Example 8

### Observational Decrease in Disease in Tomato Seedlings Treated with MDHJ

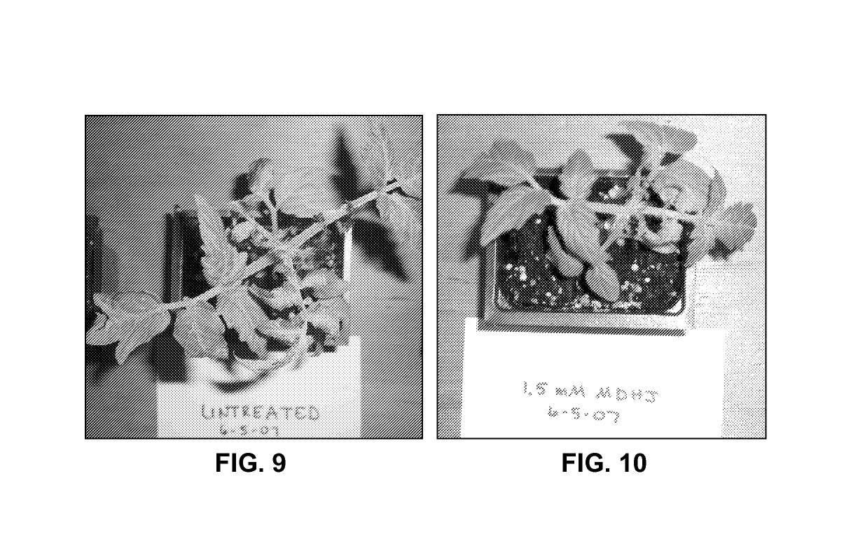

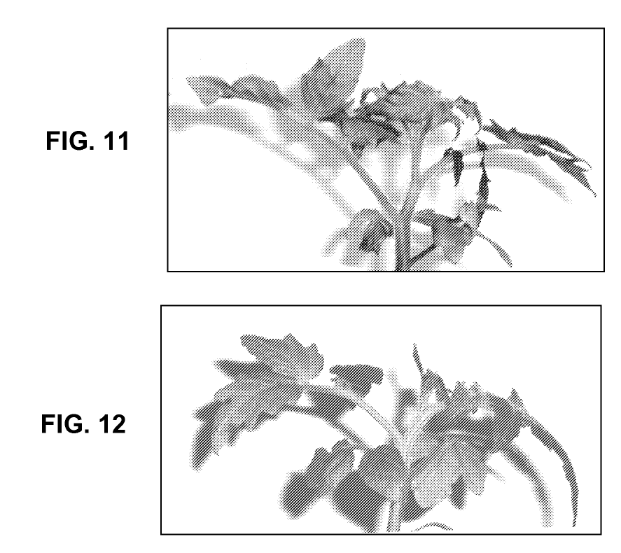

One group of tomato seedlings was treated with a formulation comprising 1.5 mM MDHJ, 0.5% canola oil, and 0.125% Triton® X-100 by spraying the foliage until the point of dripping. Another group of tomato seedlings was left untreated. Plants from each group were isolated in respective Plexiglas boxes. Photographs of the plants were taken on the 17^{th} day after treatment. One plant in each treatment group had died. Of the remaining seedings, compared to the untreated tomato seedlings, the MDHJ-treated seedlings did not show signs of disease and appeared healthier. FIG. 9 is a photograph of one of the untreated plants taken from the top, and FIG. 10 is a comparable photograph of one of the MDHJ-treated plants. Similarly, FIG. 11 is a photograph of one of the untreated plants taken from the side, and FIG. 12 is a comparable photograph of one of the MDHJ-treated plants taken from the side.

### Example 9

### Observational Decrease in Damage to Leaves of Potted Roses Treated with MDHJ

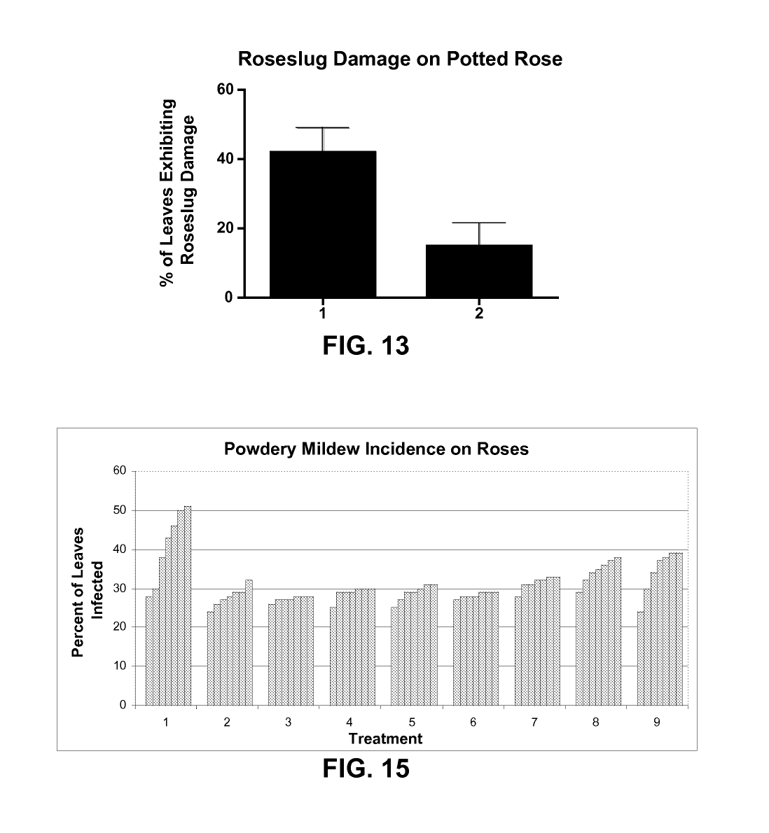

Outdoor potted roses of ‘Little White Pet’ were either left untreated or received a foliar spray of the formulation 1.5 mM MDHJ+0.5% Canola Oil+0.125% Triton® X-100. Plants were sprayed until the point of drip. Each treatment was comprised of 4 plants. Fifty-two days after treatment, plants were evaluated for incidence and severity of a natural occurrence of roseslug, larvae of sawfly, Endelomyia aethiops. FIG. 13 is a graph of roseslug damage on the treated and untreated potted roses, and Table 10 describes the incidence of roseslug damage on treated and untreated rose plants as percent of leaves showing damage. FIG. 14 is a photograph illustrating leaves from untreated plants (top row) and leaves from treated plants (bottom row) for purposes of comparison. Each leaf was taken from a separate plant.

TABLE 10
Roseslug Damage in Potted Rose.

| | | | |
|---|---|---|---|
| | Number of | Total Number of | Percent of Leaves |
| Plant | Damaged Leaves | Leaves | Damaged |

Treatment 1
(Untreated)

| | | | |
|---|---|---|---|
| A | 27 | 47 | 57% |
| B | 8 | 24 | 33% |
| C | 11 | 22 | 50% |
| D | 9 | 33 | 27% |

Treatment 2
(1.5 mM MDHJ + 0.5% Canola Oil + 0.125% Triton ® X-100)

| | | | |
|---|---|---|---|
| A | 7 | 44 | 16% |
| B | 8 | 24 | 33% |
| C | 3 | 42 | 7% |
| D | 1 | 28 | 4% |

### Example 10

### MDHJ in the Treatment and Control of Powdery Mildew in Roses

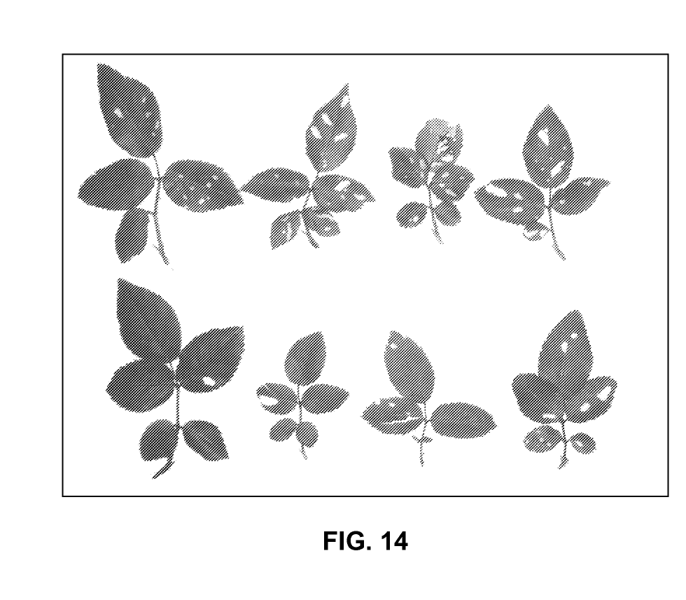

Outdoor potted roses of the cultivar ‘Mr. Lincoln’ were treated with 9 treatment samples (8 formulations and one untreated control). The treatment samples were the same as those indicated in Table 9 above. For each treatment sample, three plots having three plants each were treated for a total of 9 plants per treatment. Roses were treated every 2 weeks by spraying the foliage of each plant to the point of drip to ensure maximum coverage. Plants were initially evaluated for powdery mildew incidence and severity prior to the first treatment of the trial. At the initiation of the trial, roses exhibited similar levels of powdery mildew infection, the disease severity ranging between 10-15% on each plant. Subsequent evaluations followed every 10 days for 2 months. Evaluations consisted of evaluating 60 individual leaves per plot (20 leaves were collected from 3 rose plants per plot) for disease incidence and severity. Disease incidence was determined by counting the number of leaves infected. Disease severity was determined as the percentage of leaf surface infected with the disease. Analysis of Variance was calculated for both severity and incidence. Table 11 below describes the mean number of leaves found to be infected with powdery mildew for each treatment group on respective evaluation days. In Table 11, means followed by the same alphabetic letter do not significantly differ (P=0.05). FIG. 15 is a graph illustrating the percentage of leaves infected in each treatment group. In FIG. 15, the individual bars within each treatment represent successive evaluations on days 1, 11, 21, 31, 41, 52, and 62.

TABLE 11
Mean number of leaves infected with powdery mildew

| Treat- | | | | | | | Day |
|---|---|---|---|---|---|---|---|
| ment | Day 1 | Day 11 | Day 21 | Day 31 | Day 41 | Day 52 | 62 |
| 1 | 28 a | 30 a | 38 a | 43 a | 46 a | 50 a | 51 a |
| 2 | 24 a | 26 a | 27 a | 28 a | 29 a | 29 b | 32 b |
| 3 | 26 a | 27 a | 27 a | 27 a | 28 a | 28 b | 28 b |
| 4 | 25 a | 29 a | 29 a | 29 a | 30 a | 30 b | 30 b |
| 5 | 25 a | 27 a | 29 a | 29 a | 30 a | 31 b | 31 b |
| 6 | 27 a | 28 a | 28 a | 28 a | 29 a | 29 b | 29 b |
| 7 | 28 a | 31 a | 31 a | 32 a | 32 a | 33 b | 33 b |
| 8 | 29 a | 32 a | 34 a | 35 a | 36 a | 37 ab | 38 ab |
| 9 | 24 a | 30 a | 34 a | 37 a | 38 a | 39 ab | 39 ab |

Means followed by same letter do not significantly differ (P = .05, Student-Newman-Keuls)

The results of Example 11 indicate that MDHJ and MJ are similarly effective in slowing the progression of powdery mildew incidence beyond disease levels measured prior to the first treatment application date. By Day 52 after the trial was initiated, a statistical difference in disease incidence was measured between the untreated group and the test groups. In terms of disease severity, test formulations containing MJ and MDHJ reversed the percent of leaf surface area infected with disease over the course of the trial. A statistical difference was noted from the untreated control (treatment #1) by Day 31 of the trial. Formulations containing MJ and MDHJ were similar in their level of control of both powdery mildew incidence and severity. Results from this trial also indicate that MJ or MDHJ is an important formulation component for control of powdery mildew. This trend is especially prominent in the data, which shows a decrease in disease severity over time in treatments containing only MJ and MDHJ. Other formulation components, when combined with the active ingredient MJ or MDHJ, cause an added benefit to the decrease in powdery mildew incidence and severity over time. Although the inventors do not wish to be bound by any particular theory, the other formulation components may exert their effect by increasing leaf exposure to the active ingredient and lengthening the exposure time by limiting volatility of the active ingredient.

### Example 12

### MDHJ in the Treatment and Control of Rust in Roses

Outdoor potted roses of the cultivar ‘Mr. Lincoln’ were treated with 9 treatment samples (8 formulations and one untreated control). For each treatment sample, three plots having three plants each were treated for a total of 9 plants per treatment. Roses were treated every 2 weeks by spraying the foliage of each plant to the point of drip to ensure maximum coverage. Plants were evaluated every 10 days for 2 months. Evaluations consisted of evaluating 60 individual leaves per plot (20 leaves were collected from 3 rose plants per plot) for disease severity. Disease severity was determined as the percentage of leaf surface infected with the disease. Analysis of Variance was completed for rust severity.

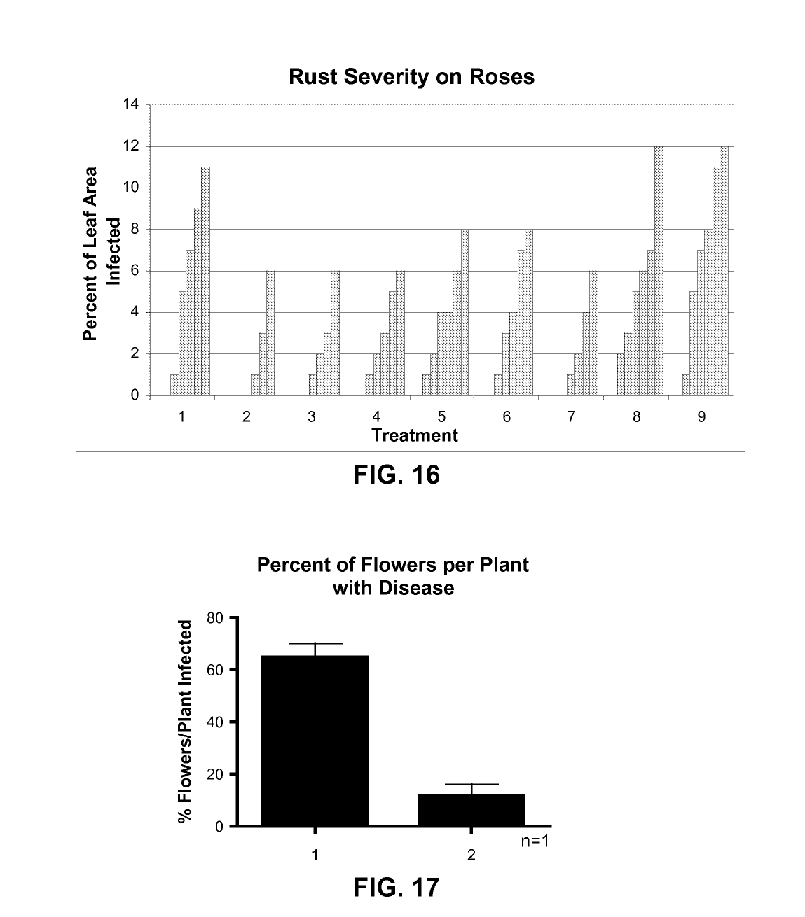

Table 12 below describes the mean number of leaves found to be infected with rust for each treatment group on respective evaluation days. In Table 12, means followed by the same alphabetic letter do not significantly differ (P=0.05). FIG. 16 is a graph illustrating the percentage of leaves infected in each treatment group. In FIG. 16, the individual bars within each treatment represent successive evaluations on days 11, 21, 31, 41, 52, and 62.

TABLE 12
Mean Number of Leaves Infected with Rust

| Treat- | | | | | | | Day |
|---|---|---|---|---|---|---|---|
| ment | Day 1 | Day 11 | Day 21 | Day 31 | Day 41 | Day 52 | 62 |
| 1 | 0 a | 0 a | 1 a | 5 a | 7 a | 9 a | 11 a |
| 2 | 0 a | 0 a | 0 a | 0 a | 1 a | 3 a | 6 a |
| 3 | 0 a | 0 a | 0 a | 1 a | 2 a | 3 a | 6 a |
| 4 | 0 a | 0 a | 1 a | 2 a | 3 a | 5 a | 6 a |
| 5 | 0 a | 1 a | 2 a | 4 a | 4 a | 6 a | 8 a |
| 6 | 0 a | 0 a | 1 a | 3 a | 4 a | 7 a | 8 a |
| 7 | 0 a | 0 a | 0 a | 1 a | 2 a | 4 a | 6 a |
| 8 | 0 a | 2 a | 3 a | 5 a | 6 a | 7 a | 12 a |
| 9 | 0 a | 1 a | 5 a | 7 a | 8 a | 11 a | 12 a |

Means followed by same letter do not significantly differ (P = .05, Student-Newman-Keuls)

Rust was not present on any rose plant until 21 days after the first treatment. Although rust pressure was not high and no statistical differences were noted between treatments, the data in Table 3 & FIG. 3 indicate that MJ and MDHJ-containing formulations were effective in slowing the progression of rust.

### Example 13

### Disease Control on Petals of Blooming Roses with MDHJ

Blooming mini Parade® Roses were divided into two treatment groups. Each treatment group contained 12 plants. Roses were grown indoors and plants from each treatment were isolated in clear plastic boxes, with six plants per box, under artificial grow lamps. The control group was treated by spraying foliage and flowers with water. The second, experimental group was treated by spraying foliage with a formulation comprising: 1.5 mM MDHJ, 0.5% Canola Oil, 0.125% Triton X-100, 4 mM potassium phosphate monohydrate, 0.8 mM magnesium sulfate heptahydrate, and 0.347 mM citric acid. Prior to treatment, each plant appeared to be healthy, and there was no apparent sign of biotic attack at the beginning of the experiment. Treatments occurred on Day 1 and Day 3. Plants were evaluated for the natural occurrence of petal decay and disease caused by powdery mildew on flower petals on Day 5. Each plant was evaluated by counting the number of plants exhibiting signs of disease, and by counting the number of diseased and un-diseased flowers per plant. The severity of disease as indicated by the surface area of the petal infected with disease was also observed.

Rose flowers treated with the MDHJ formulation exhibited less disease than rose flowers in the control group. On Day 5, the 12 plants from each treatment group were evaluated for presence or absence of disease. All twelve plants in the control group showed signs of powdery mildew compared to six plants in the experimental group. For the plants showing disease, the number of flowers exhibiting disease was counted and expressed as a percent of the total number of flowers per plant. FIG. 17 is a graph illustrating the mean percent and standard error of flowers per plant with disease present. As the data indicates, an average of 65% of the flowers per plant had disease present in the control group receiving the water spray. In contrast, only 12% of the flowers on roses receiving the MDHJ formulation exhibited disease.

In terms of disease severity, infected flowers from the control treatment had a larger petal surface area covered powdery mildew than flowers from the experimental group. Except for one flower in which 5% of the petal was infected, the flowers in the control group had disease covering 30-40% of the petal surface area. In contrast, petals from infected flowers in the experimental group exhibited 5% or less surface area coverage with the disease (data not shown). Disease was evident on flower petals but not on leaves or stems. Importantly, this experiment shows that the MDHJ formulation is effective in suppressing not just biotic attack to the foliage but is additionally effective in protecting flowers.

While the invention has been described with respect to certain embodiments and examples, the description is intended to be illustrative, rather than limiting. Modifications and changes may be made within the scope of the invention, which is defined by the appended claims.

What is claimed is:

1. A formulation for preventing or controlling biotic attack in a plant, comprising:
a solution of methyl dihydrojasmonate in a concentration ranging from about 0.15 mM to about 5 mM; and
an exposure-increasing ingredient.

2. The formulation of claim 1, wherein the solution is an aqueous solution.

3. The formulation of claim 2, wherein the exposure-increasing ingredient comprises a surfactant.

4. The formulation of claim 3, wherein the surfactant is selected from the group consisting of Triton® X-100, Triton® X-114, NP-40, SILWET, and sodium dodecyl sulfate.

5. The formulation of claim 3, further comprising an oil.

6. The formulation of claim 5, wherein the oil comprises canola oil.

7. The formulation of claim 2, wherein the exposure-increasing ingredient comprises Triton® X-100 in an amount of about 0.125% by weight; and
the formulation further comprises an oil in an amount of about 0.5% by weight.

8. The formulation of claim 7, wherein the methyl dihydrojasmonate is in a concentration of about 1.5 mM.

9. A formulation for preventing or controlling biotic attack in a plant, comprising:
methyl dihydrojasmonate in solid form in an amount ranging from about 0.008% to about 0.8% by weight; and
a binder.

10. A method of preventing and treating biotic attack in a plant, comprising administering an effective amount of exogenous methyl dihydrojasmonate to the plant or to a growth medium in which the plant is being grown.

11. The method of claim 10, wherein the effective amount of methyl dihydrojasmonate is in a form selected from the group consisting of emulsion, suspension, powder, hydrate, solution, granules, paste, aerosol, and volatile formulation.

12. The method of claim 11, wherein the methyl dihydrojasmonate is in solution with a compatible solvent.

13. The method of claim 12, wherein the compatible solvent comprises water.

14. The method of claim 13, wherein the effective amount of methyl dihydrojasmonate comprises a methyl dihydrojasmonate concentration in solution from about 0.15 mM to about 5 mM.

15. The method of claim 13, wherein the effective amount of methyl dihydrojasmonate comprises a methyl dihydrojasmonate concentration in solution of about 1.5 mM.

16. The method of claim 13, wherein the effective amount of methyl dihydrojasmonate comprises a methyl dihydrojasmonate concentration in solution of about 5 mM.

17. The method of claim 12, wherein the effective amount of methyl dihydrojasmonate comprises an amount of methyl dihydrojasmonate ranging from about 0.008% to about 0.8% by weight relative to other ingredients.

18. The method of claim 10, wherein administering the effective amount of exogenous methyl dihydrojasmonate comprises administering exogenous methyl dihydrojasmonate to the plant in the form of a foliar spray.

19. The method of claim 18, wherein the foliar spray is applied to the foliage of the plant until the point of drip.

20. The method of claim 10, wherein administering the effective amount of exogenous methyl dihydrojasmonate comprises administering exogenous methyl dihydrojasmonate to the plant at least once.

21. The method of claim 20, wherein administering the effective amount of exogenous methyl dihydrojasmonate comprises administering exogenous methyl dihydrojasmonate to the plant two or more times at defined intervals.

22. The method of claim 10, wherein administering the effective amount of exogenous methyl dihydrojasmonate comprises administering exogenous methyl dihydrojasmonate to the plant prior to harvest of the plant or a portion thereof.

23. The method of claim 10, wherein the plant comprises a rose plant or a tomato plant.

24. A cut rose produced by a process comprising:
applying exogenous methyl dihydrojasmonate to a rose plant or to a growth medium in which the rose plant is being grown in an amount effective to prevent or control biotic attack at least once; and
at a defined time after applying the exogenous methyl dihydrojasmonate, cutting the rose.

25. The cut rose of claim 24, produced by the process wherein applying the exogenous methyl dihydrojasmonate comprises applying an aqueous foliar spray of methyl dihydrojasmonate to the foliage of the rose plant, the aqueous foliar spray comprising methyl dihydrojasmonate in a concentration from about about 0.15 mM to about 5 mM.

26. A formulation for preventing or controlling biotic attack in a plant, comprising:
a solution of methyl jasmonate in a concentration ranging from about 0.15 mM to about 5 mM;
a surfactant; and
an oil.

27. The formulation of claim 26, wherein the oil comprises canola oil.
